(19) United States
(12) Patent Application Publication
(10) Pub. No.: US 2013/0252784 A1
(43) Pub. Date: Sep. 26, 2013

(54) FAILSAFE DEVICE FOR SHIFT-BY-WIRE SYSTEM

(71) Applicant: FUJI JUKOGYO KABUSHIKI KAISHA, Tokyo (JP)

(72) Inventors: Takahiro Kinoshita, Tokyo (JP); Koichi Inoue, Tokyo (JP)

(73) Assignee: Fuji Jukogyo Kabushiki Kaisha, Tokyo (JP)

(21) Appl. No.: 13/794,605

(22) Filed: Mar. 11, 2013

(30) Foreign Application Priority Data
Mar. 23, 2012 (JP) 2012-067702

(51) Int. Cl. B60W 10/184; B60W 10/11

(52) U.S. Cl. CPC B60W 10/184; B60W 10/11
USPC 477/92

(57) ABSTRACT

There is provided a failsafe device for a shift-by-wire system, including: a parking range operation unit with which a diver inputs a request to shift to a parking range; a control unit that changes the state of an automatic transmission to a parking range state in response to the shift request from the parking range operation unit; a failure determination unit that determines whether or not the actual state of the automatic transmission is the parking range state; and a brake device that brakes wheels of a vehicle with an actuator. The control unit brakes the wheels with the brake device when the failure determination unit determines that the actual state of the automatic transmission is not the parking range state after the request to shift to the parking range has been issued from the parking range operation unit.

### CROSS-REFERENCE TO RELATED APPLICATIONS

The present application claims priority from Japanese Patent Application No. 2012-067702 filed on Mar. 23, 2012, the entire contents of which are hereby incorporated by reference.

### BACKGROUND OF THE INVENTION

1. Field of the Invention

The present invention relates to failsafe devices for a shift-by-wire system that performs, using an electric signal, a range selection operation of an automatic transmission provided in a vehicle such as an automobile, and more particularly to a failsafe device that is capable of reliably fixing wheels even in the case where a lock mechanism is not actuated when a parking range is selected.

2. Description of the Related Art

With an automatic transmission provided in a vehicle such as an automobile, the driver switches a drive (D) range, a neutral (N) range, a reverse (R) range, and a parking (P) range by performing a range selection operation with a shift lever or the like.

Such range switching device is typically constituted by a manual valve that is linked by a mechanical linkage to the shift lever, but a shift-by-wire system has recently been suggested in which the range selection is performed by an electric signal, without using a mechanical linkage between the range selection switch and the automatic transmission.

In such shift-by-wire system, the states such as forward, reverse, and neutral are produced by switching the valve with an actuator in response to the range selection operation, and when the parking range is selected, the mechanical lock mechanism is actuated, the output shaft of the automatic transmission is locked, and the vehicle is prevented from moving.

However, with the above-described system, unintentional movement of the vehicle can occur when the appropriate state in the parking range is not assumed, for example, the lock mechanism is not actuated due to a failure or the like, even though the driver has performed the operation of selecting the parking range.

As the conventional failsafe technique relating to such shift-by-wire systems, for example, Japanese Unexamined Patent Application Publication (JP-A) No. 2007-32819 describes the configuration in which a sound or light warning is issued to the driver when the shift range of the automatic transmission does not move to the P range within a predetermined period after the driver has inputted a P range instruction.

Further, JP-A No. 2007-284036 describes the configuration in which the operation of the lock mechanism actuated in the P range in the automatic transmission and is linked to that of an electric parking brake device, and when a shifting is performed from the P range to the running range, the parking brake is released after the engagement of the lock mechanism is released, and when the shifting is performed from the running range to the P range, the lock mechanism is engaged and a parking brake is set to a brake state.

However, with the technique described in JP-A No. 2007-32819, although a warning is issued when a failure occurs, the wheels are eventually not fixed, and therefore when the driver ignores the warning or fails to react correctly, the vehicle cannot be prevented from moving.

Meanwhile, where an electric parking brake device is actuated automatically when the parking range is selected, as described in JP-A No. 2007-284036, the vehicle can be prevented from moving, but when the electric parking brake is thus always actuated each time the parking range is selected, the actuation frequency of the electric parking brake device increases, power consumption rises, and mechanical durability is difficult to ensure.

Further, since the parking brake device can freeze, for example, in a cold region, there are cases in which the driver does not use the parking brake. Therefore, such linkage control of the parking range and electric parking brake device can be itself canceled by the driver.

### SUMMARY OF THE INVENTION

With the foregoing in view, it is an object of the present invention to provide a failsafe device for a shift-by-wire system that is capable of reliably fixing the wheels even in the case where a lock mechanism is not actuated when a parking range is selected.

A first aspect of the present invention provides a failsafe device for a shift-by-wire system including: a parking range operation unit with which a diver inputs a request to shift to a parking range; a control unit that changes a state of an automatic transmission to a parking range state in response to the shift request from the parking range operation unit; a failure determination unit that determines whether or not an actual state of the automatic transmission is the parking range state; and a brake device that brakes wheels of a vehicle with an actuator. The control unit brakes the wheels with the brake device when the failure determination unit determines that the actual state of the automatic transmission is not the parking range state after the request to shift to the parking range has been issued from the parking range operation unit.

With such configuration, the wheels can be fixed and unintentional movement of the vehicle can be prevented by braking the wheels with the brake device when the actual state of the automatic transmission is not the parking range state due to a failure or the like although there is a request to shift to the parking range.

Further, when no failure has occurred, it is not necessary to actuate the electric parking brake device each time the parking range selection is made. Therefore, the actuation frequency of the electric parking brake device can be reduced and mechanical durability thereof is easily ensured. In addition, power required to drive the electric parking brake can be also reduced.

Preferably, the brake device is an electric parking brake device in which a parking brake is driven by an electric actuator.

With such configuration, by using an electric parking brake device as a brake device for failsafe operation, it is possible to maintain the vehicle is a stopped state even without supplying electric or mechanical power after the brake state has been assumed.

Preferably, the automatic transmission has a lock mechanism that is driven by an actuator and locks the rotation of an output shaft when shifting is performed to the parking range, and the failure determination unit determines whether or not the actual state of the automatic transmission is the parking range state on the basis of drive position information of the actuator.

Therefore, the state of the parking lock mechanism can be detected with a simple configuration and the failsafe control can be adequately performed.

### BRIEF DESCRIPTION OF THE DRAWINGS

FIG. 1 is a block diagram illustrating a configuration of the failsafe device for a shift-by-wire system according to an embodiment of the present invention; and

FIG. 2 is a flowchart illustrating the outline of control performed in the failsafe device shown in FIG. 1.

### DESCRIPTION OF THE PREFERRED EMBODIMENTS

In accordance with the present invention, the object of providing a failsafe device for a shift-by-wire system that can fix reliably the wheels even in the case where a lock mechanism is not actuated when a parking range is selected is attained by setting the electric parking brake device to a brake state when a parking range request is issued by the driver and shifting to the parking range cannot be performed due to a failure or the like.

### Embodiment

An embodiment of the failsafe device for a shift-by-wire system (referred to hereinbelow simply as “failsafe device”) according to the present invention is explained below.

The failsafe device of this embodiment is installed on an automobile such as a passenger car provided with a shift-by-wire system that performs the selection of the drive (D) range, reverse (R) range, neutral (N) range, and parking (P) range by an electric signal, without using a mechanical linkage mechanism between an automatic transmission, for example a CVT or a step AT, and a range selection operation unit such as a shift lever.

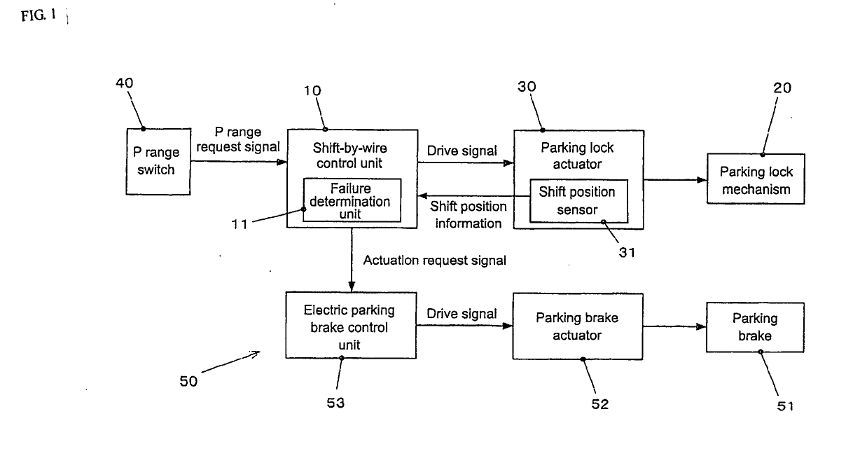

FIG. 1 is a block diagram illustrating the configuration of the failsafe device of this embodiment.

As shown in FIG. 1, the failsafe device is provided with a shift-by-wire control unit 10, a parking lock mechanism 20, a parking lock actuator 30, a parking (P) range switch 40, and an electric parking brake device 50.

The shift-by-wire control unit 10 controls the parking lock mechanism 20 or the like and includes, for example, an information processing unit such as a CPU, a storage unit such as a RAM or a ROM, an input/output interface, and a bus connecting those components.

The shift-by-wire control unit 10 is provided with a failure determination unit 11 that determines a failure of the parking lock mechanism 20, the parking lock actuator 30 and the like.

The failure determination unit 11 is described below in greater detail.

The parking lock mechanism 20 mechanically locks the output shaft and prevents the vehicle from moving when the automatic transmission is in a parking range state.

The parking lock actuator 30 is an electric actuator, for example, including a solenoid and an electric motor, that operates on the basis of a drive signal from the shift-by-wire control unit 10, drives the parking lock mechanism 20, and causes a transition from a release state to a lock state or from the lock state to the release state.

The parking lock actuator 30 is linked by a mechanical linkage mechanism to the parking lock mechanism 20.

The parking lock actuator 30 is provided with a shift position sensor 31.

The shift position sensor 31 detects the position (shift position) of the movable portion of the parking lock actuator 30 that is linked by the linkage mechanism to the parking lock mechanism 20.

The shift position sensor 31 transmits shift position information including the detected value to the shift-by-wire control unit 10.

The P range switch 40 is provided at an operation section such as a shift lever, which is used by the driver to input a range selection operation, and is set ON when the driver performs the operation of selecting the P range.

The P range switch 40 transmits a P range request signal to the shift-by-wire control unit 10 when the ON state is assumed.

The shift-by-wire control unit 10 controls the hydraulic valve of the automatic transmission in response to the P range request signal, sets a non-running state in which both the forward clutch and the reverse clutch are disengaged, transmits a drive signal to the parking lock actuator 30, and sets the parking lock mechanism 20 to a lock state.

The electric parking brake device 50 fixes the wheels and prevents the vehicle from moving when the vehicle is parked.

The electric parking brake device 50 has a parking brake 51, a parking brake actuator 52, and an electric parking brake control unit 53.

The parking brake 51 is, for example, a drum-type mechanical brake provided at a rear wheel hub of the vehicle.

The parking brake 51 is constituted by, for example, a drum formed at the inner diameter side of the rotor of the disk brake used as a service brake and a drive mechanism that causes a brake shoe, which is a friction member, to abut on the inner diameter side of the drum.

The parking brake actuator 52 drives the parking brake 51, for example, through a mechanical linkage such as a Bowden cable, and causes a transition between a brake state and a release state.

The parking brake actuator 52 has, for example, an electric motor and a gear train that reduces the output rotation thereof, and tightens or loosens the Bowden cable.

The electric parking brake control unit 53 transmits a drive signal to the parking brake actuator 52 and controls the parking brake actuator 52.

The electric parking brake control unit 53 can communicate with the shift-by-wire control unit 10, for example, by using a CAN communication system which is an on-board LAN.

The failsafe control performed in the above-described failsafe device is described below.

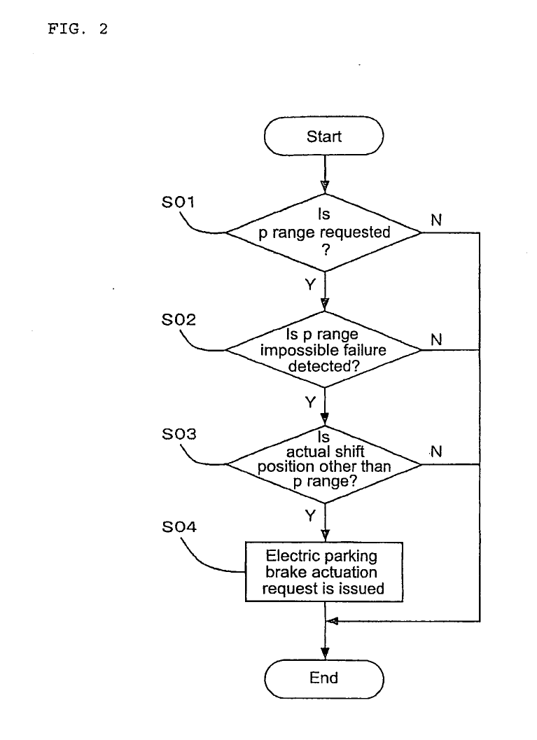

FIG. 2 is a flowchart illustrating the failsafe control.

The sequence of steps is described below.
<Step S01: Presence/absence of P range request signal is determined>

The shift-by-wire control unit 10 determines whether or not a P range request signal has been inputted from the P range switch 40.

In the case where the P range request signal has been inputted, the shift-by-wire control unit 10 transmits a drive signal to the parking lock actuator 30 that causes the actuator to lock the parking lock mechanism 20.

At this time, a transmission control unit (not shown in the figure) sets a non-running state in which both the forward clutch and the reverse clutch of the automatic transmission are disengaged.

The processing then advances to step S02.

Meanwhile, in the case where the P range request signal has not been inputted, the processing is ended (return).
<Step S02: P range impossibility failure is detected and determined>

The failure determination unit 11 of the shift-by-wire control unit 10 determines whether or not a failure has occurred in the shift-by-wire system.

The examples of failures that are the objects of detection in this case include a mechanical lock of the parking lock actuator 30, a drive circuit failure (for example, open, short, ground, and the like) of the parking lock actuator 30, a failure (for example, open, short, ground, and the like) of the shift position sensor 31, a communication failure (for example, short, ground, bus-off, data abnormality, and the like) of the CAN communication system or the like, and a failure of the shift-by-wire control unit 10 itself.

When a failure is detected, the processing advances to step S03.

Meanwhile, when no failure is detected, the processing is ended (return).
<Step S03: Actual shift position is determined>

The failure determination unit 11 of the shift-by-wire control unit 10 acquires information relating to the present actual shift position from the shift position sensor 31 of the parking lock actuator 30.

When the acquired shift position is the position corresponding to the inherent parking range state (position in which the output shaft of the automatic transmission can be locked), the processing is ended.

Meanwhile, when the acquired shift position is not the position corresponding to the inherent parking range state, the processing advances to step S04.
<Step S04: Electric parking brake actuation is requested>

The shift-by-wire control unit 10 transmits an actuation request signal to the electric parking brake control unit 53 of the electric parking brake device 50.

The electric parking brake control unit 53 that has received the actuation request signal transmits a drive signal to the parking brake actuator 52, changes the state of the parking brake 51 from the release state to the brake state, and ends the processing.

In the above-described embodiment, when a failure occurs in the parking lock mechanism of the shift-by-wire system or the actuator thereof and the output shaft of the automatic transmission is not locked although the driver issues a P range request, the vehicle can be prevented from moving by setting the electric parking brake device to a brake state as a failsafe control.

### Modification

The present invention is not limited to the above-described embodiment and various modifications and changes are possible. Those modifications and changes are also included in the technical scope of the present invention.

For example, the configuration of the shift-by-wire system and the failure that is the object of determination are not limited to those of the above-described embodiment.

Further, in the embodiment, the vehicle is prevented from moving by actuating an electric parking brake when a failure occurs. Alternatively, the vehicle may be also prevented from moving by a service brake by using, for example, an operation mode control device that can generate a fluid pressure of the service brake and a fluid pressure maintaining device that maintains the brake pressure.

What is claimed is:

1. A failsafe device for a shift-by-wire system, comprising:
a parking range operation unit to allow a diver to input a request to shift to a parking range;
a control unit to change a state of an automatic transmission to a parking range state in response to the shift request from the parking range operation unit;
a failure determination unit to determine whether or not an actual state of the automatic transmission is the parking range state; and
a brake device that brakes wheels of a vehicle with an actuator, wherein
the control unit brakes the wheels with the brake device when the failure determination unit determines that the actual state of the automatic transmission is not the parking range state after the request to shift to the parking range has been issued from the parking range operation unit.

2. The failsafe device for a shift-by-wire system according to claim 1, wherein
the brake device is an electric parking brake device in which a parking brake is driven by an electric actuator.

3. The failsafe device for a shift-by-wire system according to claim 1, wherein
the automatic transmission has a lock mechanism that is driven by an actuator and locks the rotation of an output shaft when shifting is performed to the parking range, and
the failure determination unit determines whether or not the actual state of the automatic transmission is the parking range state on the basis of drive position information of the actuator.
